(19) United States
(12) Patent Application Publication
(10) Pub. No.: US 2007/0012237 A1
(43) Pub. Date: Jan. 18, 2007

(54) Pedestrian cross walk marker

(76) Inventor: Zdenek Nielsen, Campbell, CA (US)

Correspondence Address: FOOTHILL LAW GROUP, 777 N. FIRST STREET, SUITE325, SAN JOSE, CA, 95112, US

(21) Appl. No.: 11/183,212

(22) Filed: Jul. 16, 2005

(51) Int. Cl. G08G 1/095; E01F 9/00

(52) U.S. Cl. 116/63 R; 340/907

(57) ABSTRACT

A multidimensional pedestrian crosswalk marker is disclosed. The marker typically includes three triangular surfaces and is three dimensional. Other shapes and dimensions may also be employed. Some of the surfaces may be coupled to each other and some may be separated. The surfaces may be defined by solid or broken lines or other shapes. Varying color combinations may be employed to accentuate the effect. Words, such as STOP, may also e written on one or more surfaces.

### BACKGROUND OF THE INVENTION

1. Field of the Invention

The invention relates generally to signs warning vehicular traffic of presence of pedestrians on the roadways and more particularly to a more effective way of alerting drivers to presence of pedestrian traffic.

2. Description of Related Art

Crossing streets at uncontrolled, i.e., no traffic signal or STOP sign locations can pose a serious risk to pedestrians. A variety of advisory and regulatory signs used in conjunction with existing pedestrian crosswalks are not effective for many locations, lighting and weather conditions.

A study commissioned by Federal Highway Administration (FHWA-R-00-098) published in August 2000 shows that the pedestrians who cross at mid-block account for as much as 26 percent of all motor vehicle-pedestrian crashes, according to a 1996 review of 5000 pedestrian crash reports from six different states. The study found that another 32 percent of motor vehicles-pedestrian crashes were intersection related. Ninety-three percent of the mid-block crashes and 40 percent of the intersection crashes occurred at uncontrolled intersections. In a typical year more people die at roadway crossings than in commercial airline accidents. Clearly, current pedestrian crosswalk designations are inadequate.

A recent study undertaken by the University of North Carolina at Chapel Hill for FHWA yields fresh results about crosswalks and pedestrian safety at uncontrolled intersections. This study is based on 5 years of pedestrian accident data at 1,000 marked crosswalks and 1,000 matched, unmarked crossing sites. All of the sites were uncontrolled (had no traffic signal or stop sign on the approaches). Amongst other findings, the study also showed that the type of crosswalk marking presently in existence (e.g. parallel lines, solid bar, zebra or ladder striped) and the condition of the crosswalk marking (e.g. excellent, good, fair or poor) had no significant effect on pedestrian accident rates.

According to the Spring 2003 of the Technology Transfer Newsletter, the following are traffic fatality facts:
Pedestrians account for 12% of all traffic fatalities.
Over three-quarters (78%) of all pedestrian fatalities occur at non-intersections, and over half (54%) of these are on roads without crosswalks.
Of the pedestrian fatalities at intersections, over 40% are at intersections with no marked crosswalk.
About 30% of all pedestrian fatalities are related to improper crossing of the roadway or intersection.
In 47% of the pedestrian-fatal single-vehicle accidents, alcohol was involved for either the driver or the pedestrian. In considering how to provide safer crossings for pedestrians, the question should not simply be: “Should there be a marked crosswalk or not?” Instead, the question should be: “What are the most effective measures that can be used to help pedestrians safely cross the street?” Providing marked (painted) crosswalks is only one of the many measures that may be used at a pedestrian crossing to improve safety.

Appropriate measures will also depend on site conditions.

There is considerable controversy in the U.S. over whether providing marked crosswalks will increase or decrease pedestrian safety at crossing locations not controlled by a traffic signal or stop sign. Public opinion generally holds that a marked crosswalk is a tool that works to enhance pedestrian mobility and safety. Markings are viewed as proof that pedestrians have a legitimate right to share the roadway. However, by legal definition, crosswalks may exist whether they are marked or not. Crosswalks, legally are defined as existing at all public street intersections, marked or unmarked; marked crosswalks are only required at mid-block locations. People tend to “feel” safer crossing in a crosswalk; many assume that drivers will be able to see the crosswalk markings equally as well as pedestrians, making it safer to cross between the lines.

Installation of marked crosswalks at uncontrolled pedestrian crossing locations should not be regarded as a magic cure for pedestrian safety problems. However, marked crosswalks should also not be considered as a negative measure that will increase pedestrian accidents in all cases. Marked crosswalks are appropriate at some locations to help channel pedestrians to preferred crossing locations, but in many cases should be accompanied by other improvements.

A variety of pedestrian facilities have been found to improve pedestrian safety and/or ability to cross the street under various conditions. Considerations must always include pedestrians with disabilities and ADA requirements. Some examples for use at uncontrolled and/or signalized intersections include:
Provide a median. Raised medians and crossing islands can improve pedestrian safety by giving pedestrians refuge when crossing multi-lane roads. Raised medians may provide aesthetic improvement and may control access to prevent unsafe turns out of driveways, as well. Refuge islands should be at least 4′ wide and of adequate length for pedestrian storage while waiting for gaps. Landscaping should be designed and maintained to provide good visibility between pedestrians and approaching motorists from both directions.
Install signals. On some high volume or multi-lane roads, traffic and pedestrian signals may be necessary. Audible signals assist the visually impaired. Countdown displays provide information to the pedestrian regarding the amount of time remaining to safely cross the street, which may help pedestrians make better decisions about when to enter, or not enter, the crosswalk.
Reduce street crossing distance. Curb extensions at intersections or mid-block locations to reduce the effective street crossing distance for pedestrians.
Utilize traffic calming techniques. Raised crosswalks can control vehicle speeds on local streets and at pedestrian crossings.
Provide adequate nighttime lighting. Adequate nighttime lighting is particularly important near schools, churches, and community centers with nighttime pedestrian activity.
Construct a grade separated crossing or pedestrian only street. Pedestrian bridges are very expensive and would only be considered in extreme situations, such as where pedestrian crossings are essential (e.g. school children crossing a highway), street crossing at-grade is not feasible for pedestrians, and no other measures are considered appropriate.
Supplement crossing with pedestrian warning signs. Warning signs, flashers, and other traffic control devices can be used at unusually hazardous locations or in places where pedestrian crossing activity is not readily apparent.
Install railings to direct pedestrians to their right while crossing. Directing pedestrians to the right after crossing the first half of the street increases the likelihood of looking for oncoming vehicles before crossing the second half of the street.
Use more two- and three-lane roads when designing new road networks so fewer multi-lane arterials are required.
Post an advance stop line with warning sign “STOP HERE FOR CROSSWALK.”
Eliminate parking across the crosswalk, or so close to the crosswalk that sight distance and visibility are impaired.
Employ remote sensing technologies. Microwave or infrared detectors can be used to sense pedestrians waiting to cross, replacing or augmenting the standard push button used to activate the pedestrian call feature. Or, remote sensing can be used to detect pedestrians in the crosswalk and extend the clearance interval as necessary.
Install in-pavement lighting to alert motorists to the presence of a pedestrian crossing or preparing to cross the street. Lighting can be activated for a fixed time interval, only when the signal displays “WALK”, or combined with ITS technology to be activated only when a pedestrian is in the crosswalk.
Adopt a transmitter/receiver system at signalized intersections. Infrared or LED transmitters located at the “pedestrian crossing ahead” can transmit a speech message to hand-held receivers to assist the visually impaired. Audible messages may identify the location and direction of travel of the pedestrian, give the name of the street to be crossed, and provide real-time information when it's safe for the pedestrian to cross.

### REFERENCES

Shankar, Umesh. Pedestrian Roadway Fatalities. Report No. DOT-HS-809-456, National Highway Traffic Safety Administration, Washington, D.C., April 2003.
Zegeer, C., Stewart, J., and Huang, H. Safety Effects of Marked vs. Unmarked Crosswalks at Uncontrolled Locations. Report No. FHWA-RD-01-142, Federal Highway Administration, McLean, Va., May 2001. Executive summary at:
Herms, B. “Pedestrian Crosswalk Study: Accidents in Painted and Unpainted Crosswalks.” Record No. 406, Transportation Research Board, Washington, D.C., 1972.
Zegeer, C. V., Seiderman, C., Lagerwey, P., and Cynecki, M. Pedestrian Facilities User's Guide: Providing Safety and Mobility. Federal Highway Administration, Washington, D.C., 1999.
Design and Safety of Pedestrian Facilities. Institute of Transportation Engineers, March 1998.
Zegeer, C. and Seiderman, C. “Designing for Pedestrians,” Chapter 19. The Traffic Safety Toolbox, Institute of Transportation Engineers, 1999.

Local agencies typically paint crosswalks at uncontrolled locations on the basis of average daily traffic, pedestrian volumes and other considerations. Variations of crosswalk markings include parallel lines, ladder, continental style, zebra and crosswalks painted completely in white. Additionally, a variety of overhead and side-mounted signs, such as “Stop When Flashing”, pedestrian safety cones and advance crosswalk signs drawing motorists' attention to the approaching pedestrian crosswalk are employed.

As the above quoted statistics show, current pedestrian crosswalk warnings are inadequate for many locations and lighting conditions. Stripes paved on the surface are often difficult to see and crosswalk warning signs may be lost in the background clutter of buildings and business signs. Enhanced street lighting and traffic signals are far more useful in making crosswalks more visible but also far more expensive to install and maintain, necessitating that they be reserved for only for the busiest locations.

A number of approaches have been developed in an attempt to alleviate this problem. U.S. Pat. No. 5,406,276 provides a cross-walk warning system which detects pedestrian presence at the crosswalk and activates a light which is aimed across intersection, so that an approaching driver might see the light beam and be warned of the pedestrian's presence. The lights are supported by poles located on the sidewalks. Thus, the light emanates from the sides of the road and is directed parallel to the crosswalk illuminating the pedestrian. Therefore, only a portion of the light may actually be seen by the driver.

The U.S. Pat. No. 4,993,868 describes a continuous horizontal road marking tape. The road marking tape includes light emitting diodes or high intensity microlamps, solar cells, and retroreflecting elements. The road marking tape balances the solar energy captured by its solar cells with the emitted light employed to signal or warn motorists.

The U.S. Pat. No. 5,160,202 describes an illuminated concrete curbstone. The curbstone is adopted to be partially immersed in the ground adjacent a driveway. The concrete curbstone block has an internal illuminated housing for projecting light onto a driveway. The housing has a transparent window receding from the flat front face of concrete. The illuminated curbstone is adopted to project light onto the driveway at a level above ground.

U.S. Pat. No. 5,438,495 describes an illuminated light fitting for runaways. The light fitting, which included a light source with a reflector as well as a limited light opening in the filed of light, is intended to be embedded in the surfacing of a runaway.

An integrally formed linear light strip with light emitting diodes is described in U.S. Pat. No. 5,927,845. The light strip includes first and second bus elements spaced apart from one another by a predetermined distance. An extruded plastic material completely encapsulates the first and second bus elements and the LED, thereby providing a barrier to protect the elements from damage and to make the light strip impervious to moisture.

U.S. Pat. No. 6,354,714 describes a lighting system for marking flooring, walkways, roadways and airport runaways employing LED's mounted on an I-beam shaped framework and encapsulated in a clear or reflective potting material and the upper portion of the housing for the LED lighting system being covered with a reflective coating or tape. The embedded LED system can be controlled by motion sensors, pressure sensors, or crosswalk lights.

Other illumination schemes are described in U.S. Pat. No. 2,332,362; U.S. Pat. No. 3,996,556 and U.S. Pat. No. 4,080,085. Such systems have not gained acceptance due to the cost of installation and maintenance. Other approaches utilize coatings applied to markings that reflect light of the oncoming traffic and thus alert the drivers, such as U.S. Pat. No. 3,253,146. The disadvantage of such approach is that it requires use of pigment that will fluoresce when illuminated with ultraviolet light. The lifetime of such pigments is relatively short. Another problem with fluorescing markings is that the markings must be visible when illuminated with natural daylight and also when illuminated with artificial light. Furthermore, it is very difficult to produce weather durable road markings whose fluorescent properties will remain unimpaired over long periods of time.

U.S. Pat. No. 6,758,567 describes a continuously formed, low profiled reflective pavement marker comprising a multiple, inclined, low profiled reflective portions, which are integrally connected by horizontally positioned reflective sheeting, each raised reflective portion integrally having multiple reflective cube corner elements within two defined inclined reflective faces. Each of the opposite reflective faces are integrally supported by load carrying structural walls in a multidirectional manner, said load carrying structural walls defining cell like areas within each inclined reflective face.

U.S. Pat. No. 6,703,108 describes marking material comprising on the top surface thereof an enclosed-lens retroreflective sheet that comprises a monolayer of retroreflective elements wherein first portions of the monollayer are arranged in an upwardly contoured profile and second portions of the monolayer are arranged in a lower, substantially planar position.

The cost and reliability of many of these approaches have made them difficult to implement.

Therefore, there is a need for a pedestrian crosswalk marking that is very readily visible by the oncoming traffic and also very economical to install. The invention disclosed herein meets that need.

### SUMMARY OF THE INVENTION

The pedestrian cross walk marker of this invention provides a low cost and yet very effective multidimensional warning system that may be successfully employed in the streets, highways, parking lots and wherever there is a potential for pedestrian and vehicle interaction. The three or more dimensional appearance of the marker makes it more apparent to a driver than the traditional crosswalk marker. Adding reflective characteristics to the marker would make it even more effective.

It is therefore an object of this invention to provide at least one multidimensional marker having at least one surface and applied to pavement surface.

Another object the present invention is to have multidimensional markers be in contact with each other or to be placed separately from each other.

A further object of this invention is to have the multidimensional marker be a three dimensional marker with defined triangular surfaces.

It is an object of the present invention to employ solid or broken lines and other shapes to define the surfaces.

Still another object of the present invention is to position triangularly shaped multidimensional marker so that one vertex of the triangle is aimed at the approaching vehicle.

Yet another object of the present invention is to position triangularly shaped multidimensional marker so that one of the triangle edges is approximately perpendicular to the direction of traffic flow and being closer to the oncoming vehicle than the other edges.

A further object of this invention is to provide a multidimensional marker whose surfaces have varying colors.

Still another object of the present invention is to provide a multidimensional marker that is a cube, pentagon, hexagon or an object with as many sides necessary to maximize the effect.

Yet another object of the present invention is to include other shapes, letters or numbers in the surfaces of the multidimensional marker.

It is an object of the present invention to include the word STOP on one of the surfaces of the multidimensional marker.

Another object of the present invention is to paint or apply by adhesive means the multidimensional marker to a pavement.

The pedestrian crosswalk marker of this invention thus provides pedestrians a low cost and improved degree of personal safety while crossing streets, highways or parking lots.

### BRIEF DESCRIPTION OF THE DRAWINGS

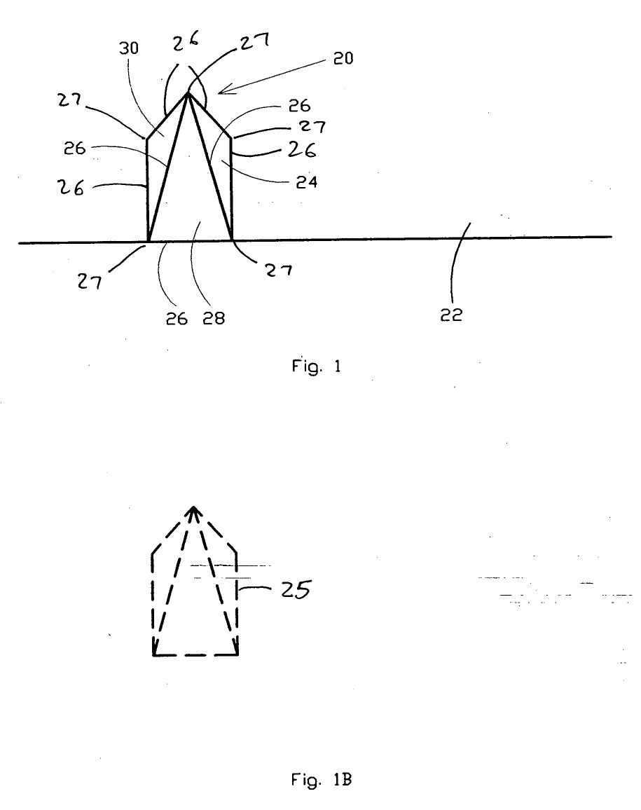

1. FIG. 1 shows the triangular three dimensional triangular crosswalk marker.

2. FIG. 1B is the marker of FIG. 1 employing broken lines to define the triangles.

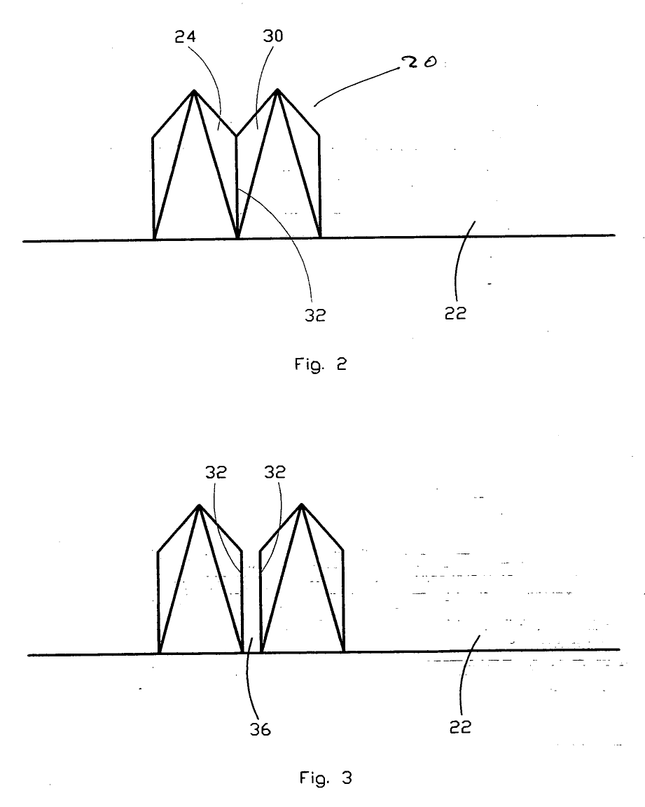

3. FIG. 2 shows two triangular markers in contact with each other.

4. FIG. 3 shows triangular markers separated from each other.

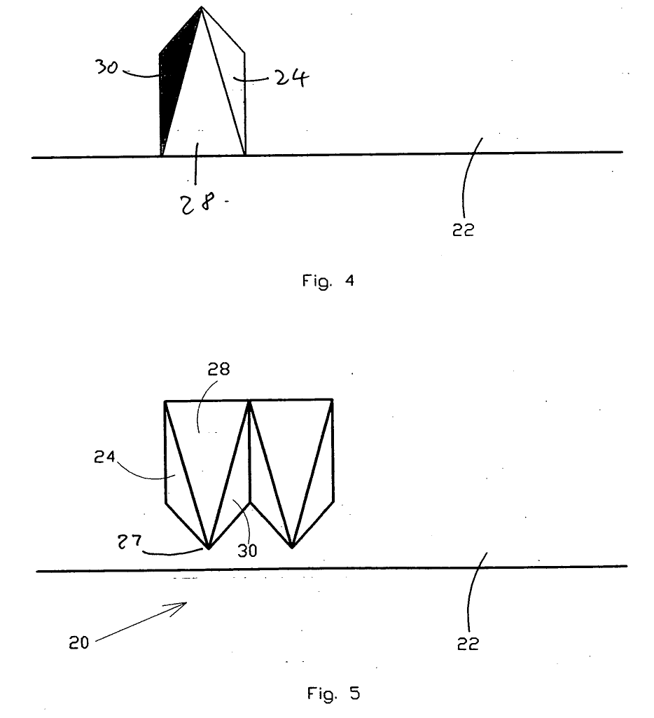

5. FIG. 4 is a color version of the marker of FIG. 1

6. FIG. 5 is a marker with vertices pointing at the oncoming traffic.

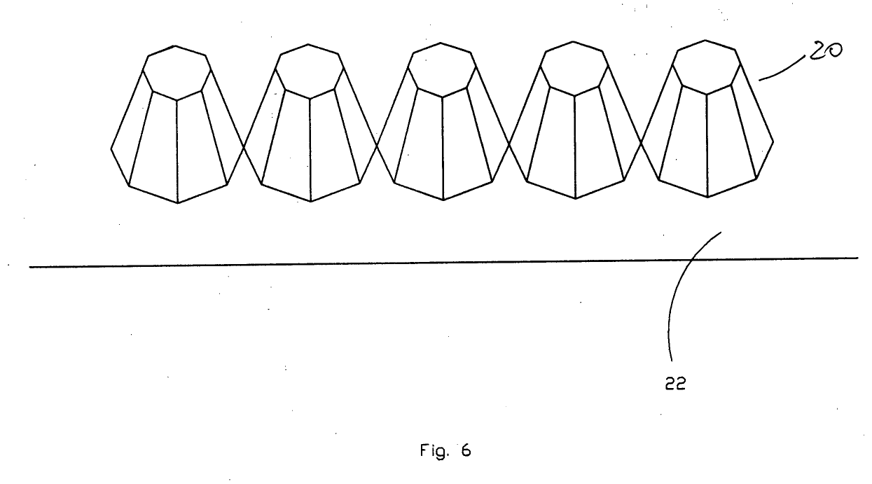

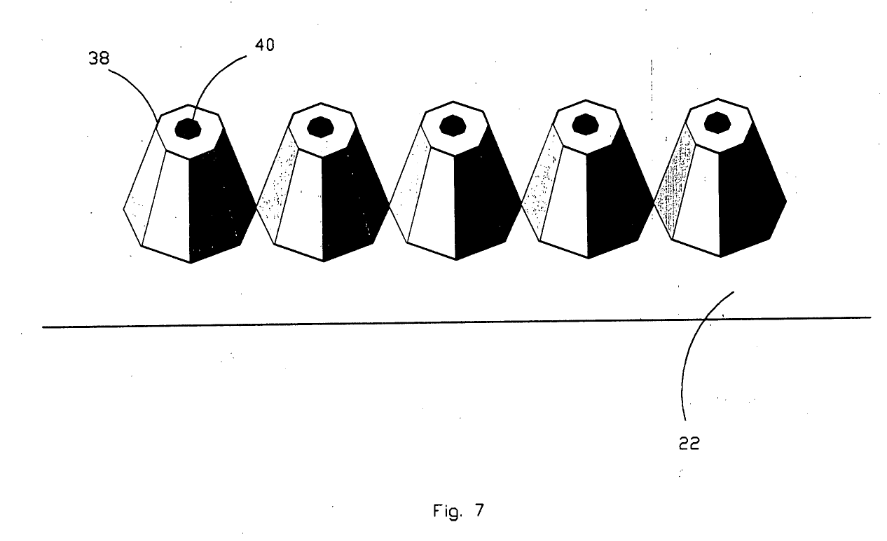

7. FIG. 6 is an octagonal marker.

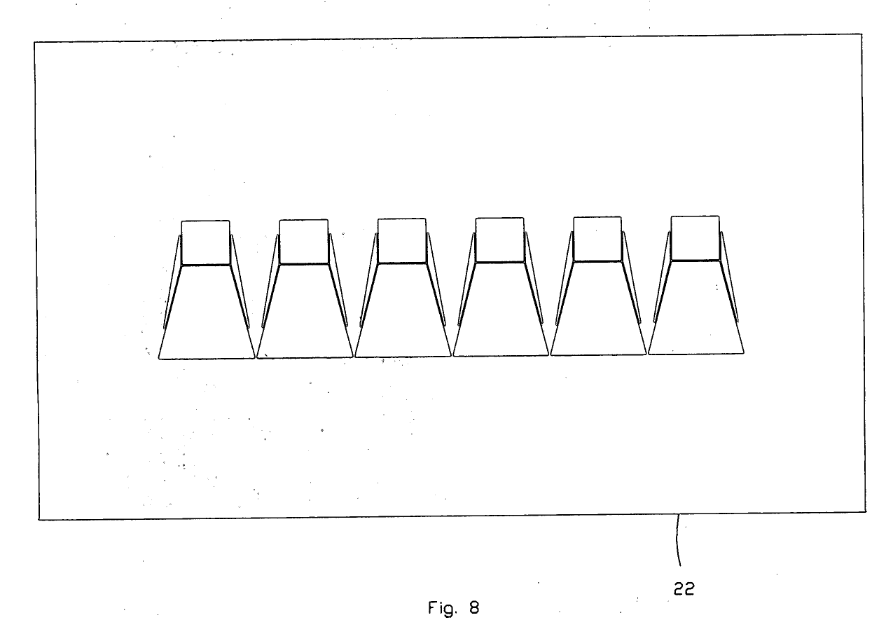

8. FIG. 7 shows an octagonal marker with another octagonal shape in the top surface.

9. FIG. 8 is a truncated pyramid type of marker.

### DETAILED DESCRIPTION OF THE DRAWINGS

Referring now to the drawings, FIG. 1 shows a marker 20 of this invention made on pavement 22 of a typical pedestrian crossing. The marker 20 has three triangular surfaces 24, 28 and 30. The surfaces 24, 28 and 30 are defined by lines 26, that all meet at vertices 27.The lines 26 may be solid straight or solid curved lines, or the lines 26 may be broken into segments, such segments either following straight line relative to each other, or such segments being angled relative to each other. If surfaces 24, 28, and 30 are all of different color from each other and also different from that of the pavement 22, lines 26 may not be needed. The surfaces 24, 28 and 30 are preferably of colors that easily distinguishes them from the pavement 22, or they may all be of the same color so long as lines 26 clearly separate sides 24, 28 and 30 from the pavement 22. In one embodiment side 28 is white, side 30 is yellow, side 24 is black and pavement 22 is gray. Additionally, the surfaces 24, 28 and 30 may also all be white or any other color easily distinguishable from the pavement 22 and be separated from each other by a line of different color, while the pavement 22 remains of color easily differentiated from that of the sides 24, 28 and 30. Any combination of colors for surfaces 24, 28, and 30 is possible so long as they accentuate the marker 20 relative to the pavement 22.

FIG. 1B shows the marker 20 of this invention where lines 26 are broken into straight segments 25. The segments 25 may also be angled relative to each other and may take on shape of a curve, dot, triangle, circle, ellipse or similar object.

FIG. 2 shows multiple marker 20 adjacent to each other on the pavement 22 and preferably occupying an entire pedestrian crossing. The line 32 may be shared by the surfaces 24 and 30.

Shown in FIG. 3 are the surfaces 24 and 30 that have been separated by two or more lines 32 with a high contrast color in space 36 between the lines 32 relative to surfaces 24 and 30 and separating the surfaces 24 and 30.

FIG. 4 shows a color version of marker 20 of FIG. 4, where the surface 28 is white, the surface 30 is gray, the surface 24 is yellow and the pavement 22 is black. Other combinations of colors may also be employed.

FIG. 5 is the marker 20 turned 180 degrees from the position occupied in FIG. 2 with the vertex 27 of the side 28 pointing in the direction of the driver. Again, the marker 20 may be positioned adjacent to each other or may be separated as described in the description of FIG. 3.

Shown in FIG. 6 is a marker 20 with that has 8 surfaces drawn on pavement 22.

FIG. 7 is a color version of FIG. 6 with mark 40 being red or other conspicuous color positioned in surface 38 for maximizing the effect on the approaching driver. Alternatively, surface 38 or any other surface may include the word STOP, be shaped as a stop sign commonly found on a roadway, or embody other signs of caution.

In all situations described, the marker 20 may be positioned so that they are facing the driver as described in the appended figures or the marker 20 may be turned some amount. A person skilled in the art will be able to determine the best position of marker 20 for maximum effect. Any combinations of color arrangements for maximizing visibility to the driver of a vehicle may also be employed.

The marker 20 may be painted onto the pavement, it may be applied by means of an adhesive or some other suitable approach.

The preferred embodiments of the present invention disclosed herein are intended to be illustrative only and are not intended to limit the scope of the invention. It should be understood by those skilled in the art that various modifications and adaptations of the present invention as well as alternative embodiments of the present invention may be contemplated.

It is to be understood that the present invention is not limited to the sole embodiments described above, but encompasses any and all embodiments within the scope of the following claims.

What is claimed is:

1. A device for alerting vehicle traffic to presence of pedestrians and to guide pedestrians, comprising:
a traffic bearing surface having a color; and
at least one multi dimensional signal member having surfaces and coupled to said traffic bearing surface and having at least one color.

2. The device of claim 1 wherein at least one multidimensional signal member is coupled to another multidimensional signal member.

3. The device of claim 1 wherein said at least one multidimensional signal member is not coupled to another multidimensional signal member.

4. The device of claim 1 wherein said at least one multi dimensional signal member further comprises lines, line segments, circles, triangles and polygons; said lines, line segments, circles, triangles and polygons defining at least three surfaces in said at least one multi dimensional signal member, said at least three surfaces having at least one color; said multidimensional marker being three dimensional marker.

5. The device of claim 4 wherein said at least three surfaces are triangularly shaped, each surface having first edge, second edge and third edge, said first edge and said second edge meeting at fist vertex, said first and third edge meting at second vertex and said second and third edge meeting at third vertex.

6. The device of claim 5 wherein each triangularly shaped surface is of different color from an adjacent surface.

7. The device of claim 6 wherein at least one of the surfaces is white.

8. The device of claim 5 wherein said first triangle edge is more proximate the approaching vehicle than the other edges and is approximately perpendicular to the direction of vehicle travel; said second and third edges running from the first edge and forming a vertex away from the first edge.

9. The device of claim 5 wherein first triangle vertex is more proximate the approaching vehicle than the second and third triangle vertices; said second and third positioned distally form the first triangle vertex and defining a triangle edge that is approximately perpendicular to the traffic flow.

10. The device of claim 1 wherein said at least one multidimensional signal member further comprises 4, 5, 6, 7 or 8 sides.

11. The device of claim 1 wherein at least one surface further comprises other shapes, characters, letters, numbers or designs.

12. The device of claim 11 wherein said other letters form the word STOP.

13. The device of claim 11 wherein the shapes, characters and designs are polygons, said polygons having a color different from the surface comprising the polygon.

14. The device of clam 1 wherein said at least one multidimensional signal member further comprises light reflecting material.

15. The device of clam 1 wherein said at least one multidimensional signal member is painted onto said traffic bearing surface.

16. The device of clam 1 wherein said at least one multidimensional signal member is adheringly applied onto said traffic bearing surface.
